(19) United States
(12) Patent Application Publication
(10) Pub. No.: US 2024/0028912 A1
(43) Pub. Date: Jan. 25, 2024

(54) PREDICTIVELY ROBUST MODEL TRAINING

(71) Applicant: NEC CORPORATION, Tokyo (JP)

(72) Inventors: Vivek BARSOPIA, Tokyo (JP); Yoshio KAMEDA, Tokyo (JP); Tomoya SAKAI, Tokyo (JP); Keita SAKUMA, Tokyo (JP); Ryuta MATSUNO, Tokyo (JP)

(21) Appl. No.: 17/863,338

(22) Filed: Jul. 12, 2022

(51) Int. Cl. G06N 5/02

(52) U.S. Cl. CPC G06N 5/022

(57) ABSTRACT

Predictively robust models are trained by embedding a distribution of each temporal data set among a plurality of temporal data sets into a feature vector, predicting a future feature vector of a distribution of a future data set, based on the feature vector of each temporal data set among a plurality of temporal data sets, creating the future data set from the future feature vector, perturbing the future data set to produce a plurality of perturbed future data sets, and training a learning function using the future data set and each perturbed future data set to produce a model.

### BACKGROUND

In supervised machine learning, training is based on a training data set that has been curated by those familiar with the process. Curation of a training data set can be an extensive and costly process, involving many man-hours. Once a model has been trained by the training data set, many more man-hours may be spent verifying the trained model before implementation. After implementation, performance of the trained model is monitored for accuracy and effectiveness. The model is retrained when the accuracy or effectiveness is no longer adequate. Even when the model has been carefully trained and verified, accuracy or effectiveness will eventually lose adequacy due to data drift, changes in environment, etc. For usage of models in some applications, it is not a question of if the model will be retrained, but when.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an operational flow for predictively robust model training, according to at least some embodiments of the subject disclosure.

FIG. 2 is a diagram of a data set having classes and sub-populations, according to at least some embodiments of the subject disclosure.

FIG. 3 is an operational flow for data set distribution embedding, according to at least some embodiments of the subject disclosure.

FIG. 4 is a map of feature vectors representing temporal data set distributions, according to at least some embodiments of the subject disclosure.

FIG. 5 is an operational flow for future feature vector prediction, according to at least some embodiments of the subject disclosure.

FIG. 6 is a map showing a future feature vector among temporal data set distribution feature vectors, according to at least some embodiments of the subject disclosure.

FIG. 7 is an operational flow for future data set creation, according to at least some embodiments of the subject disclosure.

FIG. 8 is an operational flow for future data set perturbation, according to at least some embodiments of the subject disclosure.

FIG. 9 is a map showing feature vectors of a perturbed future data set among temporal data set distribution feature vectors, according to at least some embodiments of the subject disclosure.

FIG. 10 is an operational flow for learning function training, according to at least some embodiments of the subject disclosure.

FIG. 11 is a diagram of a first classification function for a data set having classes and sub-populations, according to at least some embodiments of the subject disclosure.

FIG. 12 is a diagram of a second classification function for a data set having classes and sub-populations, according to at least some embodiments of the subject disclosure.

FIG. 13 is a block diagram of a hardware configuration for predictively robust model training, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In data classification, an algorithm is used to divide a data set into multiple classes. These classes may have multiple sub-populations or sub-categories that are not relevant to the immediate classification task. Some sub-populations or sub-categories are frequent and some are occasional. The relative frequencies of sub-populations can affect the performance of a classifier, which is an algorithm used to sort the data of the data set into the multiple classes. Some classifiers are trained using a concept known as Empirical Risk Minimization (ERM):

$$\hat{h} = arg {min}_{θ} \sum ℓ ( {h}_{θ} ( {x}_{i} ) , {y}_{i} ) , \qquad EQ . 1$$

where ĥ is the trained classifier algorithm, [symbol] is the loss function, h_{θ} is the classifier learning function, xᵢ is the input to the classifier function, h_{θ}(xᵢ) represents the class output from the classifier function, and yᵢ is the true class. However, ERM is optimized for the training data set, and does not consider uncertainty of the training data set nor data drift. As a result, if there is a shift in relative frequencies of sub-populations, then the classifier performance will degrade.

Some classification algorithms supplement the training data set with a number of synthetic data sets generated by perturbing the training data set, which represents the current state of data, such as by using the following adversarial weighting scheme:

$${ω}_{i} ∝ ℓ ( {h}_{θ} ( {x}_{i} ) , {y}_{i} ) , \qquad EQ . 2$$

$$where$$

$$ω ∈ W ; W = \{ ω \vert \sum f ( {ω}_{i} ) \leq \frac{δ}{N} , \sum {ω}_{i} = N , {ω}_{i} \geq 0 \} , \qquad EQ . 3$$

which assigns weight to loss, where, ω is an N-dimensional vector and its i^{th} element, denoted as co represents the assigned adversarial weight to i^{th} sample in the data set, N is the number of samples in the data set, and W is created by producing a divergence ball, such as f-diverge, chi-squared divergence, KL divergence, etc., around the data set used for training. Classifiers using the adversarial weighting scheme in EQS. 2 and 3 are trained using the following min-max loss function:

$$\hat{h} = arg {min}_{θ} {max}_{ω ∈ W} \sum {ω}_{i} * ℓ ( {h}_{θ} ( {x}_{i} ) , {y}_{i} ) . \qquad EQ . 4$$

However, such algorithms do not consider data drift, and are sensitive to the amount of divergence. As divergence increases, robustness increases, but so does the likelihood of unrealistic sub-population frequencies, which increases the risk of reduced performance on the current data state and decreases longevity. This problem is sometimes referred as extreme pessimism in Distributionally Robust Optimization (DRO).

Some algorithms consider historical data, extrapolate a data drift trend, and forecast a future data set.

In at least some embodiments described herein, classifiers and other models are produced in consideration of data drift and training data set uncertainty through predictively robust model training. In at least some embodiments, a time series of data is used to predict a future state, which is then supplemented with perturbations of a distribution or density function of the future state to create a training data set that, when used to train a model, results in a predictively robust model. In at least some embodiments, resulting predictively robust models exhibit greater longevity than models trained using classification algorithms that perturb a training data set that represents the current state of data, because the actual future state is more likely to fall within the scope of divergence, sometimes referred to as a “divergence ball”, centered around a forecasted state rather than a current state. Because the actual future state is more likely to fall within the scope of divergence centered around a forecasted state, at least some embodiments use a divergence that is smaller than a divergence centered around a current state, which reduces the likelihood of unrealistic sub-population frequencies, further increasing the longevity of the model.

In at least some embodiments, classifiers are trained to perform well on sub-populations that have low frequency at the time of training. In at least some embodiments, predictively robust model training improves the lifespan of the model, which reduces the number of models in archive, reduces costs of model retraining, such as man-hours involved in compliance, quality control, training data set curation, and the computational resources required to retrain the model.

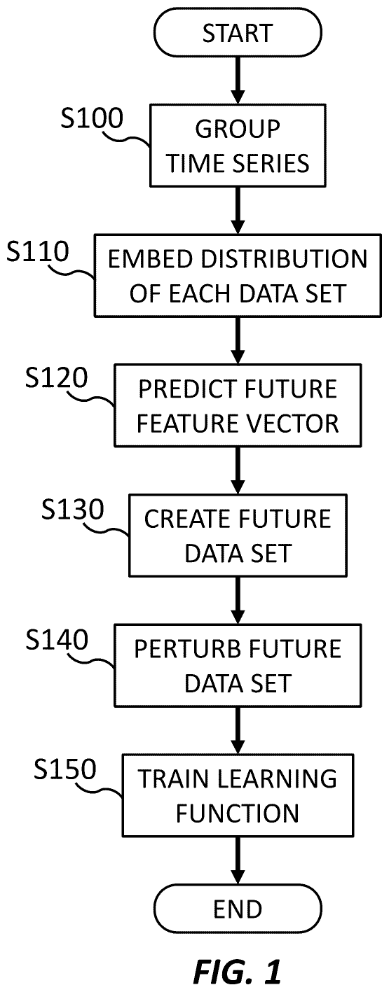

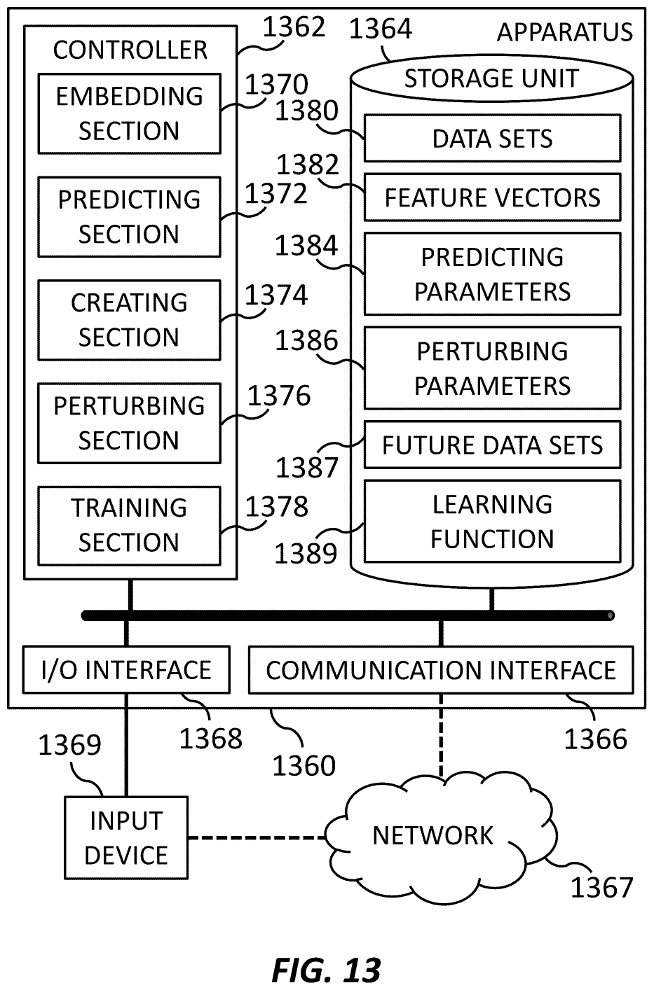

FIG. 1 is an operational flow for predictively robust model training, according to at least some embodiments of the subject disclosure. The operational flow provides a method of predictively robust model training. In at least some embodiments, one or more operations of the method are executed by a controller of an apparatus including sections for performing certain operations, such as the controller and apparatus shown in FIG. 13, which will be explained hereinafter.

At S100, the controller or a section thereof groups a time series of data into data sets. In at least some embodiments, the controller groups the time series of data into a plurality of temporal data sets. In at least some embodiments, the time series is grouped into evenly spaced time steps. In at least some embodiments, each group represents historic training data of a model. In at least some embodiments, each group includes a distribution of data samples that represent the state at the corresponding time. In at least some embodiments, the group that includes a distribution of the most recent data samples represents the current state. In at least some embodiments, each group includes a density function that represents the state at the corresponding time. In at least some embodiments, the controller receives a time series that has already been grouped, and proceeds directly to distribution data set embedding at S110.

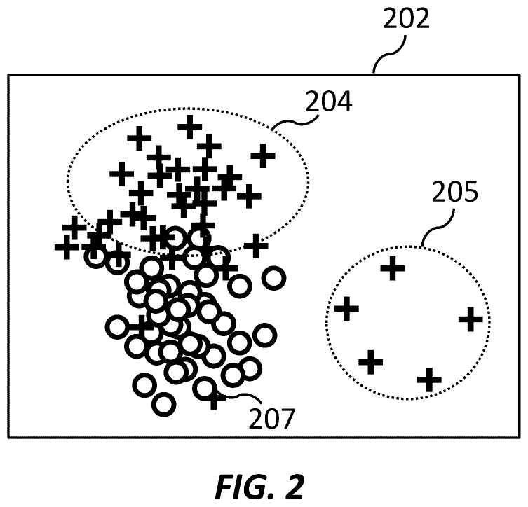

At S110, an embedding section embeds a distribution of each data set. In at least some embodiments, the embedding section embeds a distribution of each temporal data set among a plurality of temporal data sets into a feature vector. In at least some embodiments, the embedding section estimates a probability density function of each temporal data set. In at least some embodiments, the embedding section performs the data set distribution embedding process described hereinafter with respect to FIG. 2.

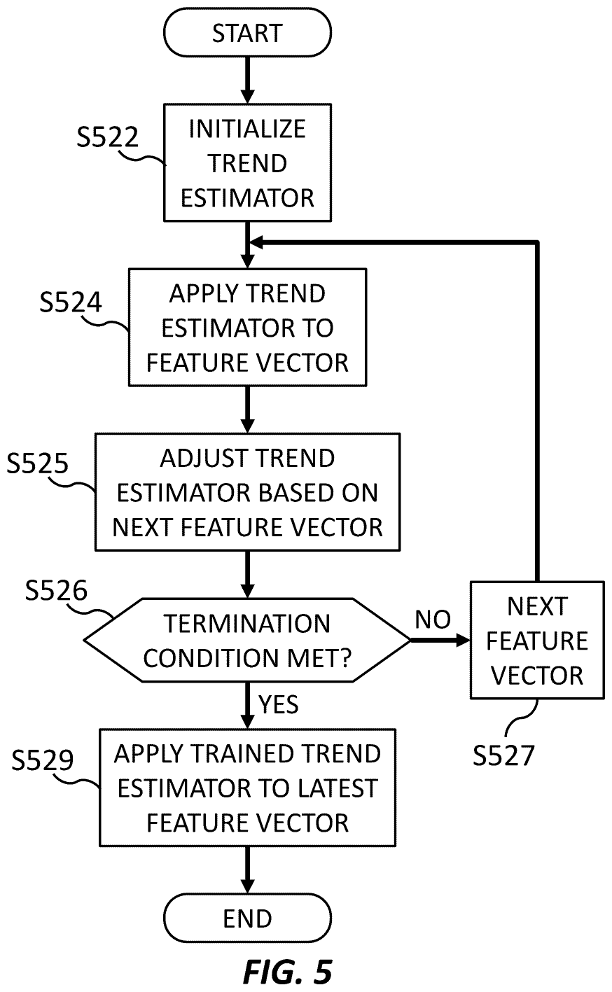

At S120, a predicting section predicts a future feature vector. In at least some embodiments, the predicting section predicts a future feature vector of a distribution of a future data set, based on the feature vector of each temporal data set among a plurality of temporal data sets. In at least some embodiments, the predicting section determines a data drift trend. In at least some embodiments, the predicting section forecasts a future feature vector by extrapolating a data drift trend exhibited by the historical data. In at least some embodiments, the predicting section performs the future feature vector prediction process described hereinafter with respect to FIG. 5.

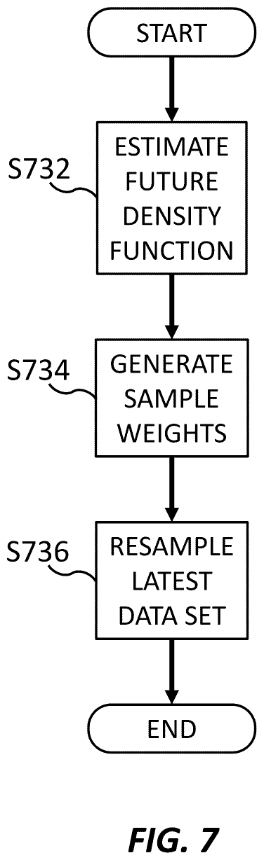

At S130, a creating section creates a future data set. In at least some embodiments, the creating section creates the future data set from the future feature vector predicted at S120. In at least some embodiments, the creating section decodes the future feature vector into a future probability density function, generates weights according to the difference between the future probability density function and a probability density function of the current state, and resamples the data set representing the current state according to the generated weights. In at least some embodiments, the creating section performs the future data set creation process described hereinafter with respect to FIG. 7.

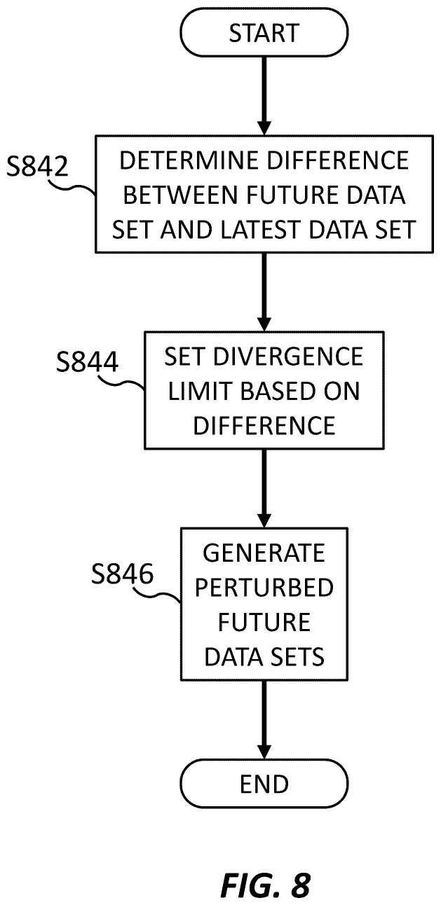

At S140, a perturbing section perturbs a future data set. In at least some embodiments, the perturbing section perturbs the future data set to produce a plurality of perturbed future data sets. In at least some embodiments, the perturbing section supplements a data set representing a future state with perturbations of the distribution or density function of the future state to create a training data set that, when used to train a model, results in a predictively robust model. In at least some embodiments, the perturbing section performs the future data set perturbation process described hereinafter with respect to FIG. 8.

At S150, a training section trains a learning function. In at least some embodiments, the training section trains a learning function using the future data set and each perturbed future data set to produce a model. In at least some embodiments, the training section trains the learning function to classify the samples in the future data set and each perturbed future data set. In at least some embodiments, the learning function is linear classifier. In at least some embodiments, the learning function is a non-linear classifier. In at least some embodiments, each sample includes a label representing a ground truth classification. In at least some embodiments, the learning function is trained to output the classification represented by the label in response to application to the sample.

FIG. 2 is a diagram of a data set 202 having classes and sub-populations, according to at least some embodiments of the subject disclosure. In at least some embodiments, data set 202 is a temporal data set that includes a plurality of samples. Each sample is characterized by x and y coordinates, and is paired with a label that reflects the class to which it belongs. The classes include a first class, denoted in FIG. 2 by +, and a second class, denoted in FIG. 2 by ∘. FIG. 2 shows each sample as the corresponding label and plotted at a position consistent with the x and y coordinates of the sample's characterization.

The first class of data set 202 has two visible sub-populations, shown as sub-population 204, and sub-population 205. Sub-population 204 has many samples, but sub-population 205 has only five samples. It should be understood that sub-population 204 and sub-population 205 are not represented in the information provided in data set 202. Instead, sub-population 204 and sub-population 205 may have some commonality in the underlying data that makes up data set 202, or from which data set 202 was formed, but such commonality is not actually represented in the information provided in the data set. As such, sub-population 205 may not have any commonality, and may exist purely by coincidence. On the other hand, sub-population 205 may underrepresent an actual commonality. In at least some embodiments, it is not necessary to be certain whether sub-population 205, or any other sub-population of data set 202, actually has commonality.

The first class of data set 202 has a noisy sample 207. Noisy sample 207 is labeled in the first class, but is surrounded by nothing but samples from the second class. Noisy sample 207 is considered to be a noisy sample not because it is believed to be incorrectly labeled, but rather because it will not help in the process of producing a classification model. In other words, even if a classification model was trained to correctly label sample 207, such classification model would likely be considered “overfit”, and thus not accurate for classifying data other than in data set 202.

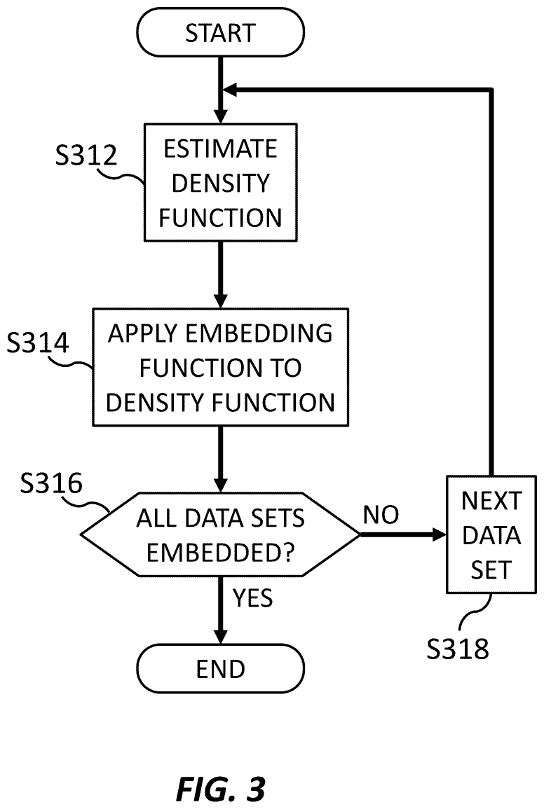

FIG. 3 is an operational flow for data set distribution embedding, according to at least some embodiments of the subject disclosure. The operational flow provides a method of data set distribution embedding. In at least some embodiments, one or more operations of the method are executed by an embedding section of an apparatus, such as the apparatus shown in FIG. 13, which will be explained hereinafter.

At S312, the embedding section or a sub-section thereof estimates a density function of a data set. In at least some embodiments, as iterations of the operational flow proceed, the embedding section estimates a density function of each temporal data set among the plurality of temporal data sets. In at least some embodiments, the embedding section utilizes a parametric or non-parametric density estimator. In at least some embodiments, the embedding section estimates a point density function of each temporal data set on a weighted sum basis. In at least some embodiments, the embedding section expresses P_{D}_{ⱼ} (the point density function for temporal data set j), as a mixture of of basis density functions P_{b}_{ᵢ} according to the following function:

P_{D}_{ⱼ}(X=x)=Σᵢ₌₁^{K}αᵢ*P_{b}_{ᵢ}(X;) EQ. 5,

where αᵢ indicates weight assigned to i^{th} basis density function P_{b}_{ᵢ}, the feature vector [α₁, α₂, . . . α_{K}]∈R^{k}, P_{D}_{ⱼ} is the point density function for temporal data set j, and K is the feature vector length, x is a sample, X is the classification. In at least some embodiments, basis density functions P_{b}_{ᵢ} can be computed using Mixture Model algorithms, such as a Gaussian Mixture Model (GMM). In at least some embodiments P_{b}_{ᵢ}(S) can also be manually generated by data scientists.

At S314, the embedding section or a sub-section thereof applies an embedding function to the density function estimated at S312. In at least some embodiments, as iterations of the operational flow proceed, the embedding section embeds the density function of each temporal data set. In at least some embodiments, the embedding section puts the feature vector [α₁, α₂, . . . , α_{K}] of the density function into a Euclidean space. In at least some embodiments, the embedding section utilizes Principal Component Analysis (PCA), Independent Component Analysis (ICA), or another dimension reduction technique to compress the feature vector length from K dimensions to L dimensions [β₁, β₂, . . . β_{L}] such that [β₁, β₂, . . . β_{L}]=[α₁, α₂, . . . α_{K}]*W, where K>L, and W∈R^{K*L}. In at least some embodiments, the embedding section utilizes a dimension reducing technique to improve prediction of a future feature vector.

At S316, the embedding section or a sub-section thereof determines whether all data sets have been embedded. If the embedding section determines that unembedded temporal data sets remain, then the operational flow returns to density function estimation at S312 to estimate the density function of the next temporal data set (S318). If the embedding section determines that all of the temporal data sets have been embedded into feature vectors, then the operational flow ends.

In at least some embodiments, the embedding section embeds the distribution of each temporal data set without estimating the density function. In at least some embodiments, the embedding section embeds the distribution of each temporal data set directly into feature vector.

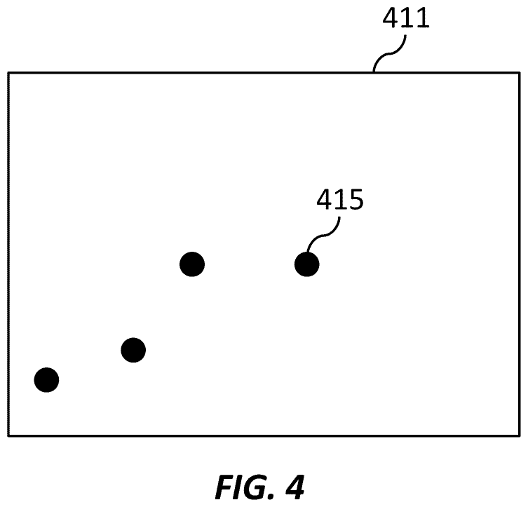

FIG. 4 is a map 411 of feature vectors representing temporal data set distributions, according to at least some embodiments of the subject disclosure. Map 411 shows a feature vector of each temporal data set, such as feature vector 415, which represents the temporal data set of the current state, mapped into a Euclidean space of two dimensions. In at least some embodiments, the embedding section embeds each temporal data set into a feature vector of more than two dimensions, making it difficult to visualize. However, it is not necessary to visualize or interpret feature vectors. Map 411 and the feature vectors mapped thereon are simplified for demonstration.

FIG. 5 is an operational flow for future feature vector prediction, according to at least some embodiments of the subject disclosure. The operational flow provides a method of future feature vector prediction. In at least some embodiments, one or more operations of the method are executed by a predicting section of an apparatus, such as the apparatus shown in FIG. 13, which will be explained hereinafter.

At S522, the predicting section or a sub-section thereof initializes a trend estimator. In at least some embodiments, the trend estimator is a Multivariate Time Series Forecasting learning function which learns a formula to express future observation as a function of past observations using historical time series data. In at least some embodiments, the trend estimator is an Auto-Regressive Integrated Moving Average (ARIMA(p,d,q)) model. In at least some embodiments, the predicting section assigns random values between zero and one to the parameters of the trend estimator.

At S524, the predicting section or a sub-section thereof applies the trend estimator to a feature vector. In at least some embodiments, the predicting section applies the trend estimator to the parameters [α₁, α₂, . . . α_{K}] of the feature vector. In at least some embodiments, as iterations of the operational flow proceed, the predicting section applies the trend estimator to each feature vector.

At S525, the predicting section or a sub-section thereof adjusts the trend estimator based on the next feature vector. In at least some embodiments, the predicting section adjusts the trend estimator by comparing the output resulting from application to the feature vector to the parameters of the feature vector representing a subsequent temporal data set. In at least some embodiments, the feature vectors are training samples, each labeled with the feature vector representing the subsequent temporal data set. In at least some embodiments, the feature vector representing the current state is not used as a training sample, but only as a label for the feature vector representing the preceding temporal data set.

At S526, the predicting section determines whether a termination condition has been met. In at least some embodiments, as iterations of the operational flow proceed, the predicting section trains a trend estimator to output a temporally subsequent feature vector in response to application to each feature vector except for a latest feature vector. In at least some embodiments, the termination condition is met when a predetermined number of training samples have been processed, or a predetermined number of epochs have been performed. In at least some embodiments, the termination condition is met when an error calculated from a loss function has become smaller than a threshold amount. In at least some embodiments, the termination condition is met when the trend estimator has converged on a solution. If the termination condition has not yet been met, then the operational flow returns to trend estimator application at S524 to apply the next feature vector (S527). If the termination condition has been met, then the operational flow proceeds to trained trend estimator application at S529.

At S529, the predicting section or a sub-section thereof applies the trained trend estimator to the latest feature vector. In at least some embodiments, the predicting section applies the trend estimator to the latest feature vector to output the future feature vector. In at least some embodiments, the predicting section applies the trend estimator to the feature vector representing the current state to obtain a feature vector representing a future data set.

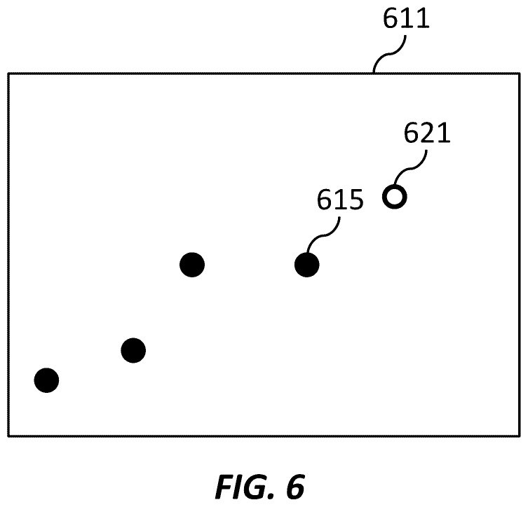

FIG. 6 is a map 611 showing a future feature vector 621 among temporal data set distribution feature vectors, according to at least some embodiments of the subject disclosure. Map 611 also shows a feature vector of each temporal data set, such as feature vector 615, which represents the temporal data set of the current state. Map 611 is substantially similar in structure and function to map 411 of FIG. 4, except where indicated otherwise.

FIG. 7 is an operational flow for future data set creation, according to at least some embodiments of the subject disclosure. The operational flow provides a method of future data set creation. In at least some embodiments, one or more operations of the method are executed by a creating section of an apparatus, such as the apparatus shown in FIG. 13, which will be explained hereinafter.

At S732, the creating section or a sub-section thereof estimates a future density function. In at least some embodiments, the creating section estimates a density function of the future data set. In at least some embodiments, the creating section applies the parameters [α₁, α₂, . . . α_{K}] of the future feature vector to EQ. 5 to obtain P_{D}_{_{F}}, where F indicates a temporal step into the future from the current state.

At S734, the creating section or a sub-section thereof generates sample weights. In at least some embodiments, the creating section generates sample weights based on the density function of the future data set and a density function of the latest data set among the plurality of temporal data sets. In at least some embodiments, the creating section generates samples weights wᵢ for each sample in the latest data set, which represents the current state, according to the following formula:

$${w}_{i} = \frac{{P}_{{D}_{F}} ( {x}_{i} )}{{P}_{{D}_{C}} ( {x}_{i} )} , \qquad EQ . 6$$

where P_{D}_{_{c}} is the point density function representing the latest data set, and P_{D}_{_{F}} is the point density function representing the future data set.

At S736, the creating section or a sub-section thereof resamples the latest data set. In at least some embodiments, the creating section resamples the latest data set according to the sample weights generated at S734. For example, a wᵢ=3 indicates that sample xᵢ is three times more likely to appear in the future data set than the current data set, and the creating section therefor generates three samples xᵢ in the future data set for every sample xᵢ in the latest data set.

In at least some embodiments, the creating section creates the future data set directly from the future feature vector.

FIG. 8 is an operational flow for future data set perturbation, according to at least some embodiments of the subject disclosure. The operational flow provides a method of future data set perturbation. In at least some embodiments, one or more operations of the method are executed by a perturbing section of an apparatus, such as the apparatus shown in FIG. 13, which will be explained hereinafter.

At S842, the perturbing section or a sub-section thereof determines a difference between the future data set and the latest data set. In at least some embodiments, the perturbing section utilizes a distance measuring algorithm to determine a distance between the future data set and the latest data set. In at least some embodiments, the perturbing section determines the difference based on the feature vectors representing the future data set and the latest data set.

At S844, the perturbing section or a sub-section thereof sets a divergence limit based on the difference between the future data set and the latest data set. In at least some embodiments, the perturbing section sets a divergence limit δ according to the difference. In at least some embodiments, the perturbing section bases the divergence limit on a difference between the future data set and the latest temporal data set. In at least some embodiments, the perturbing section sets the divergence limit to be greater than or equal to the difference between the future data set and the latest temporal data set.

At S846, the perturbing section or a sub-section thereof generates perturbed future data sets. In at least some embodiments, the perturbing section utilizes a Distributionally Robust Optimization (DRO) method to supplement the future data set with perturbed future data sets. In at least some embodiments, the perturbing section generates perturbed future data sets by perturbing the future data set using the adversarial weighting scheme in EQ. 2 and EQ. 3. In at least some embodiments, each perturbed future data set diverges from the future data set within the predetermined divergence limit.

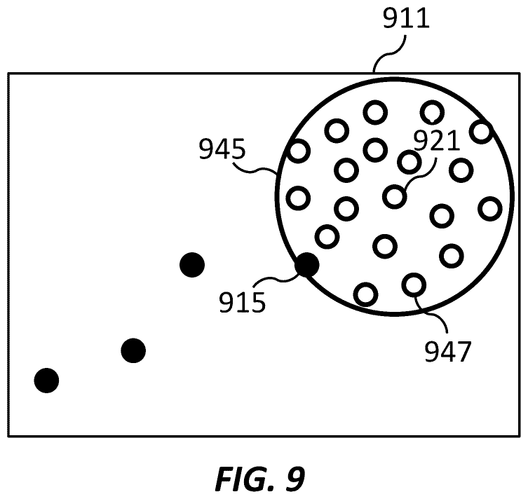

FIG. 9 is a map 911 showing feature vectors of a perturbed future data set among temporal data set distribution feature vectors, according to at least some embodiments of the subject disclosure. Map 911 shows a plurality of feature vectors representing perturbed future data sets, such as feature vector 947, distributed around future feature vector 921. Map 911 also shows a boundary 945 centered around future feature vector 921, representing the extent to which the perturbed future data sets differ from the future data set. Boundary 945 intersects feature vector 915 representing the latest data set to indicate that the divergence limit to be greater than or equal to the difference between the future data set and the latest temporal data set. Map 911 is substantially similar in structure and function to map 611 of FIG. 6, except where indicated otherwise.

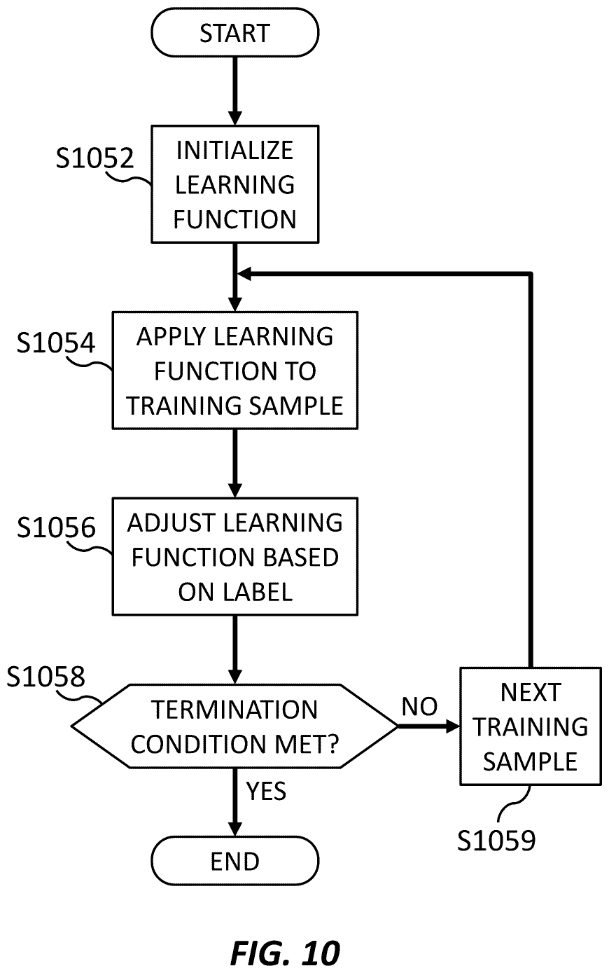

FIG. 10 is an operational flow for learning function training, according to at least some embodiments of the subject disclosure. The operational flow provides a method of learning function training. In at least some embodiments, one or more operations of the method are executed by a training section of an apparatus, such as the apparatus shown in FIG. 13, which will be explained hereinafter.

At S1052, the training section or a sub-section thereof initializes a learning function. In at least some embodiments, the learning function is a classification model. In at least some embodiments, the training section assigns random values between zero and one to the parameters of the learning function.

At S1054, the training section or a sub-section thereof applies the learning function to a training sample. In at least some embodiments, the training section provides the training sample as input to the learning function, and obtains output values. In at least some embodiments, the training section provides the training sample as input to the learning function, and obtains an output class. In at least some embodiments, the training section provides the training sample as input to the learning function, and obtains, for each class, a probability that the training sample belongs to the class. In at least some embodiments, the training sample is selected from among samples of the future data set and the perturbed future data sets.

At S1056, the training section or a sub-section thereof adjusts the learning function based on the label of the training sample. In at least some embodiments, the training section compares the output values to the label, and determines the difference. In at least some embodiments, the training section applies a loss function to the output values and the label to obtain a loss value. In at least some embodiments, the training section adjusts weights and other parameters of the learning function based on the loss value. In at least some embodiments, the training section adjusts the weights by utilizing gradient descent. In at least some embodiments, the training section does not adjust the learning function in every iteration of the operational flow.

At S1058, the training section determines whether a termination condition has been met. In at least some embodiments, as iterations of the operational flow proceed, the training section trains a learning function to output a classification in response to application to each training sample. In at least some embodiments, the termination condition is met when a predetermined number of training samples have been processed, or a predetermined number of epochs have been performed. In at least some embodiments, the termination condition is met when a loss calculated from the loss function has become smaller than a threshold loss. In at least some embodiments, the termination condition is met when the learning function has converged on a solution. If the termination condition has not yet been met, then the operational flow returns to learning function application at S1054 to apply the next training sample (S1059). If the termination condition has been met, then the operational flow ends.

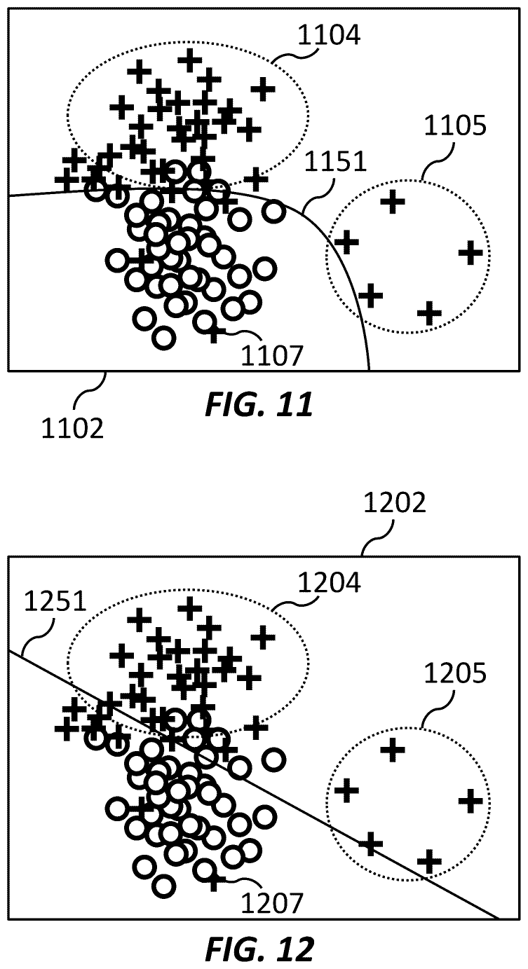

FIG. 11 is a diagram of a first classification function 1151 for a data set 1102 having classes and sub-populations, according to at least some embodiments of the subject disclosure. Data set 1102 includes sub-population 1104, sub-population 1105, and noisy sample 1107, which correspond to sub-population 204, sub-population 205, and noisy sample 207 in FIG. 2, respectively, and thus should be understood to have the same qualities unless explicitly described otherwise.

First classification function 1151 is shown plotted against data set 1102 to illustrate the decision boundary first classification function 1151 uses to determine the classification of samples in data set 1102. First classification function 1151 has a non-linear decision boundary, which is less interpretable than a linear decision boundary. Whether or not first classification function 1151 is likely to be understood or not is subjective, but a non-linear decision boundary is less likely to be understood by a given person than a linear decision boundary.

FIG. 12 is a diagram of a second classification function 1251 for a data set 1202 having classes and sub-populations, according to at least some embodiments of the subject disclosure. Data set 1202 includes sub-population 1204, sub-population 1205, and noisy sample 1207, which correspond to sub-population 204, sub-population 205, and noisy sample 207 in FIG. 2, respectively, and thus should be understood to have the same qualities unless explicitly described otherwise.

Second classification function 1251 is shown plotted against data set 1202 to illustrate the decision boundary second classification function 1251 uses to determine the classification of samples in data set 1202. Second classification function 1251 has a linear decision boundary, which is likely to be easily understood, and thus interpretable, that determines classification based on which side of the decision boundary the sample falls.

FIG. 13 is a block diagram of a hardware configuration for predictively robust model training, according to at least some embodiments of the subject disclosure.

The exemplary hardware configuration includes apparatus 1360, which interacts with input device 1369, and communicates with network 1367. In at least some embodiments, apparatus 1360 is integrated with input device 1369. In at least some embodiments, apparatus 1360 is a computer or other computing device that receives input or commands from input device 1369. In at least some embodiments, apparatus 1360 is a host server that connects directly to input device 1369, or indirectly through network 1367. In at least some embodiments, apparatus 1360 is a computer system that includes two or more computers. In at least some embodiments, apparatus 1360 is a computer system that executes computer-readable instructions to perform operations for physical network function device access.

Apparatus 1360 includes a controller 1362, a storage unit 1364, a communication interface 1366, and an input/output interface 1368. In at least some embodiments, controller 1362 includes a processor or programmable circuitry executing instructions to cause the processor or programmable circuitry to perform operations according to the instructions. In at least some embodiments, controller 1362 includes analog or digital programmable circuitry, or any combination thereof. In at least some embodiments, controller 1362 includes physically separated storage or circuitry that interacts through communication. In at least some embodiments, storage unit 1364 includes a non-volatile computer-readable medium capable of storing executable and non-executable data for access by controller 1362 during execution of the instructions. Communication interface 1366 transmits and receives data from network 1367. Input/output interface 1368 connects to various input and output units, such as input device 1369, via a parallel port, a serial port, a keyboard port, a mouse port, a monitor port, and the like to exchange information.

Controller 1362 includes embedding section 1370, predicting section 1372, creating section 1374, perturbing section 1376, and training section 1378. Storage unit 1364 includes data sets 1380, feature vectors 1382, predicting parameters 1384, future data sets 1387, and learning function 1389.

Embedding section 1370 is the circuitry or instructions of controller 1362 configured to embed data set distributions. In at least some embodiments, embedding section 1370 is configured to embed a distribution of each temporal data set into a feature vector. In at least some embodiments, embedding section 1370 utilizes information in storage unit 1364, such as data sets 380, and records information to storage unit 1364, such as feature vectors 1382. In at least some embodiments, embedding section 1370 includes sub-sections for performing additional functions, as described in the foregoing flow charts. In at least some embodiments, such sub-sections are referred to by a name associated with a corresponding function.

Predicting section 1372 is the circuitry or instructions of controller 1362 configured to predict a future feature vector. In at least some embodiments, predicting section 1372 is configured to predict a future feature vector of a distribution of a future data set, based on the feature vector of each temporal data set of the time series. In at least some embodiments, predicting section 1372 utilizes information in storage unit 1364, such as feature vectors 1382 and predicting parameters 1384, and records information to storage unit 1364, such as feature vectors 1382. In at least some embodiments, predicting section 1372 includes sub-sections for performing additional functions, as described in the foregoing flow charts. In at least some embodiments, such sub-sections are referred to by a name associated with a corresponding function.

Creating section 1374 is the circuitry or instructions of controller 1362 configured to create future data sets. In at least some embodiments, creating section 1374 is configured to create a future data set from the future feature vector. In at least some embodiments, creating section 1374 utilizes information from storage unit 1364, such as feature vectors 1382, and records information to storage unit 1364, such as future data sets 1387. In at least some embodiments, creating section 1374 includes sub-sections for performing additional functions, as described in the foregoing flow charts. In at least some embodiments, such sub-sections are referred to by a name associated with a corresponding function.

Perturbing section 1376 is the circuitry or instructions of controller 1362 configured to perturb data sets. In at least some embodiments, perturbing section 1376 is configured to perturb the future data set to produce a plurality of perturbed future data sets. In at least some embodiments, perturbing section 1376 utilizes information from storage unit 1364, such as perturbing parameters 1386 and future data sets 1387, and records information in storage unit 1364, such as future data sets 1387. In at least some embodiments, perturbing section 1376 includes sub-sections for performing additional functions, as described in the foregoing flow charts. In at least some embodiments, such sub-sections are referred to by a name associated with a corresponding function.

Training section 1378 is the circuitry or instructions of controller 1362 configured to train learning functions. In at least some embodiments, training section 1378 is configured to train a learning function using the future data set and each perturbed future data set to produce a model. In at least some embodiments, training section 1378 utilizes information from storage unit 1364, such as learning function 1389. In at least some embodiments, training section 1378 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiment of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

According to at least some embodiments of the subject disclosure, predictively robust models are trained by embedding a distribution of each temporal data set among a plurality of temporal data sets into a feature vector, predicting a future feature vector of a distribution of a future data set, based on the feature vector of each temporal data set among a plurality of temporal data sets, creating the future data set from the future feature vector, perturbing the future data set to produce a plurality of perturbed future data sets, and training a learning function using the future data set and each perturbed future data set to produce a model.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a computer to cause the computer to perform operations comprising:
embedding a distribution of each temporal data set among a plurality of temporal data sets into a feature vector;
predicting a future feature vector of a distribution of a future data set, based on the feature vector of each temporal data set among a plurality of temporal data sets;
creating the future data set from the future feature vector;
perturbing the future data set to produce a plurality of perturbed future data sets; and
training a learning function using the future data set and each perturbed future data set to produce a model.

2. The computer-readable medium of claim 1, wherein each perturbed future data set diverges from the future data set within a predetermined divergence limit.

3. The computer-readable medium of claim 2, wherein the divergence limit is based on a difference between the future data set and a latest temporal data set.

4. The computer-readable medium of claim 3, wherein the divergence limit is greater than or equal to the difference between the future data set and the latest temporal data set.

5. The computer-readable medium of claim 1, wherein the operations further comprise grouping a time series of data into the plurality of temporal data sets.

6. The computer-readable medium of claim 1, wherein embedding the distribution includes
estimating a density function of each temporal data set among the plurality of temporal data sets, and
embedding the density function of each temporal data set.

7. The computer-readable medium of claim 1, wherein the predicting includes determining a data drift trend.

8. The computer-readable medium of claim 1, wherein the predicting includes
training a trend estimator to output a temporally subsequent feature vector in response to application to each feature vector except for a latest feature vector, and
applying the trend estimator to the latest feature vector to output the future feature vector.

9. The computer-readable medium of claim 1, wherein the creating includes estimating a density function of the future data set.

10. The computer-readable medium of claim 1, wherein the creating includes generating sample weights based on the density function of the future data set and a density function of the latest data set among the plurality of temporal data sets.

11. A method comprising:
embedding a distribution of each temporal data set among a plurality of temporal data sets into a feature vector;
predicting a future feature vector of a distribution of a future data set, based on the feature vector of each temporal data set among a plurality of temporal data sets;
creating the future data set from the future feature vector;
perturbing the future data set to produce a plurality of perturbed future data sets; and
training a learning function using the future data set and each perturbed future data set to produce a model.

12. The method of claim 11, wherein each perturbed future data set diverges from the future data set within a predetermined divergence limit.

13. The method of claim 12, wherein the divergence limit is based on a difference between the future data set and a latest temporal data set.

14. The method of claim 13, wherein the divergence limit is greater than or equal to the difference between the future data set and the latest temporal data set.

15. The method of claim 11, wherein the predicting includes
training a trend estimator to output a temporally subsequent feature vector in response to application to each feature vector except for a latest feature vector, and
applying the trend estimator to the latest feature vector to output the future feature vector.

16. An apparatus comprising:
a controller including circuitry configured to
embed a distribution of each temporal data set among a plurality of temporal data sets into a feature vector,
predict a future feature vector of a distribution of a future data set, based on the feature vector of each temporal data set among a plurality of temporal data sets,
create the future data set from the future feature vector,
perturb the future data set to produce a plurality of perturbed future data sets, and
train a learning function using the future data set and each perturbed future data set to produce a model.

17. The apparatus of claim 16, wherein each perturbed future data set diverges from the future data set within a predetermined divergence limit.

18. The apparatus of claim 17, wherein the divergence limit is based on a difference between the future data set and a latest temporal data set.

19. The apparatus of claim 18, wherein the divergence limit is greater than or equal to the difference between the future data set and the latest temporal data set.

20. The apparatus of claim 16, wherein the circuitry is further configured to
train a trend estimator to output a temporally subsequent feature vector in response to application to each feature vector except for a latest feature vector, and
apply the trend estimator to the latest feature vector to output the future feature vector.
